(19) United States
(12) Patent Application Publication
(10) Pub. No.: US 2024/0053554 A1
(43) Pub. Date: Feb. 15, 2024

(54) DUAL-SIDED OPTICAL PACKAGE

(71) Applicant: NLIGHT, INC., Camas, WA (US)

(72) Inventors: Bryce TOKMAKIAN, Portland, OR (US); Mark J. DEFRANZA, Ridgefield, WA (US); Eric MARTIN, Vancouver, WA (US); Manoj Kanskar, Portland, OR (US)

(73) Assignee: NLIGHT, INC., Camas, WA (US)

(21) Appl. No.: 18/222,949

(22) Filed: Jul. 17, 2023

Related U.S. Application Data
(60) Provisional application No. 63/396,507, filed on Aug. 9, 2022.

(51) Int. Cl. G02B 6/42

(52) U.S. Cl. CPC G02B 6/4268; G02B 6/4202

(57) ABSTRACT

Various embodiments provide apparatuses, systems, and methods related to a dual-sided optical package. The package may include a base plate with a first side and a second side opposite the first side. The base plate may have a coolant channel positioned between the first side and the second side. A first set of optics may be coupled with the first side of the base plate, and a second set of optics may be coupled with the second side of the base plate. Other embodiments may be described and/or claimed.

### CROSS-REFERENCE TO RELATED APPLICATIONS

This application depends from, and claims priority to, U.S. Provisional Patent Application 63/396,507, filed Aug. 9, 2022, the contents of which are incorporated herein in their entirety.

### FIELD

Embodiments of the present invention relate generally to the technical field of optical packages, and more particularly to a dual-sided optical package.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Optical packages may be structures that are able to generate an optical signal. The number of optical packages in an electronic device may be limited by factors such as the size of the optical package, and the size of the physical device in which the optical package may be put, and the cost of manufacture of such an optical package.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a simplified view of a dual-sided optical package, in accordance with various embodiments.

FIG. 2 illustrates an alternative simplified view of the dual-sided optical package of FIG. 1, in accordance with various embodiments.

FIG. 3 illustrates a simplified view of a portion of a base plate of a dual-sided optical package, in accordance with various embodiments.

FIG. 4 illustrates an alternative simplified view of a dual-sided optical package, in accordance with various embodiments.

FIG. 5 illustrates an example technique by which a dual-sided optical package may be manufactured, in accordance with various embodiments.

FIG. 6 illustrates an example electronic device which may include a dual-sided optical package or be configured to manufacture a dual-sided optical package, in accordance with various embodiments.

FIG. 7 illustrates an example non-transitory computer-readable storage medium having instructions configured to practice all or selected ones of the operations associated with any of FIGS. 5, 6, and/or some other Figure herein, in accordance with various embodiments.

### DETAILED DESCRIPTION

As previously noted, optical packages may be structures that are able to generate an optical signal. The number of optical packages in an electronic device may be limited by factors such as the size of the optical package, and the size of the physical device in which the optical package may be put, and the cost of manufacture of such an optical package.

Specifically, with the current state of the industry, lowering the cost (which may be measured in terms of dollars per watt produced by the package) may be desirable. One cost driver in such optical packages is the base plate to which various elements of the optical package (e.g., laser diode chips, chips-on-submount (COS s), optical components, etc.) are bonded. Precise mounting of the various elements of the optical package may be important, and it may also be desirable for the base plate to provide a heat removal mechanism so that the elements do not overheat.

Embodiments herein relate to a base plate that may reduce one or more of the size, weight, and cost of an optical package. Specifically, embodiments may relate to a base plate that has a first set of optics mounted to a first side of the base plate, and a second set of optics mounted to a second side of the base plate. The base plate may also include a channel for coolant fluid (e.g., a “coolant channel”). As a result, an optical package may allow for two sets of optics that are coupled with two optical cables in from the package.

The use of such a base plate may provide significant benefits over legacy optical packages. Specifically, embodiments of the optical package described herein may have a smaller cost, mass, and/or size as compared to a “double-stacked” package layout that includes two optical packages stacked on top of one another.

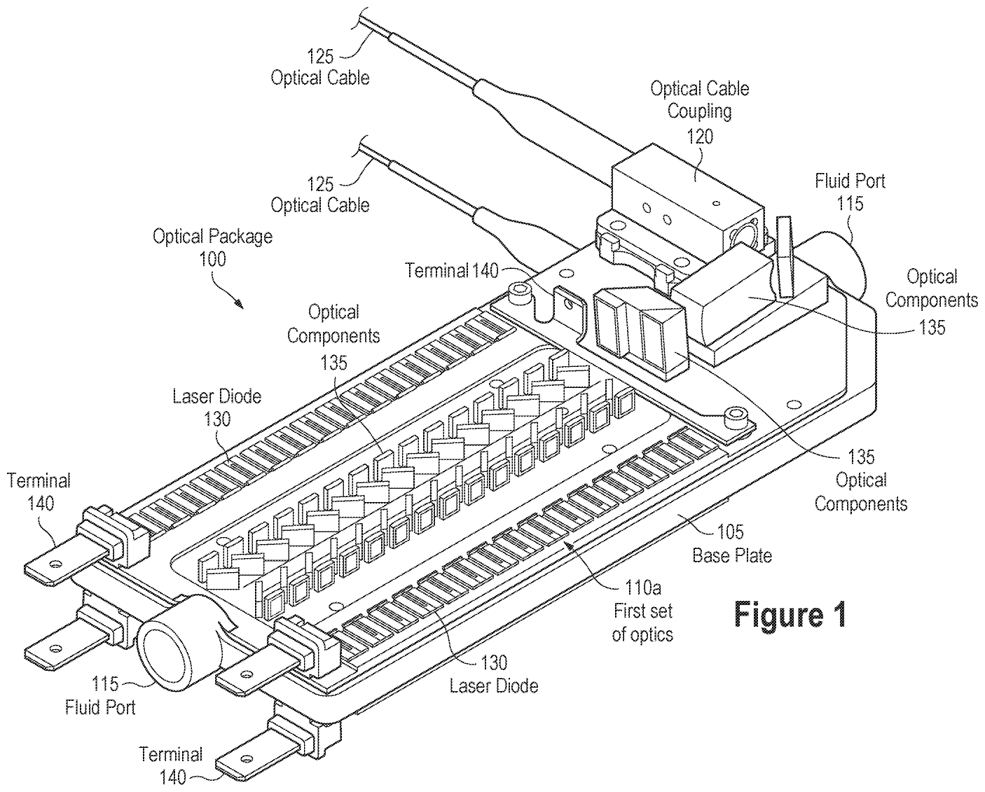

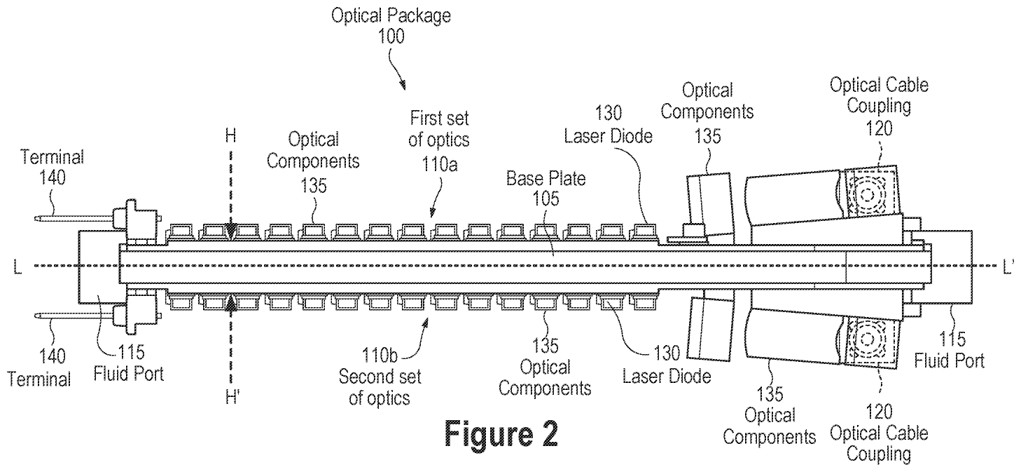

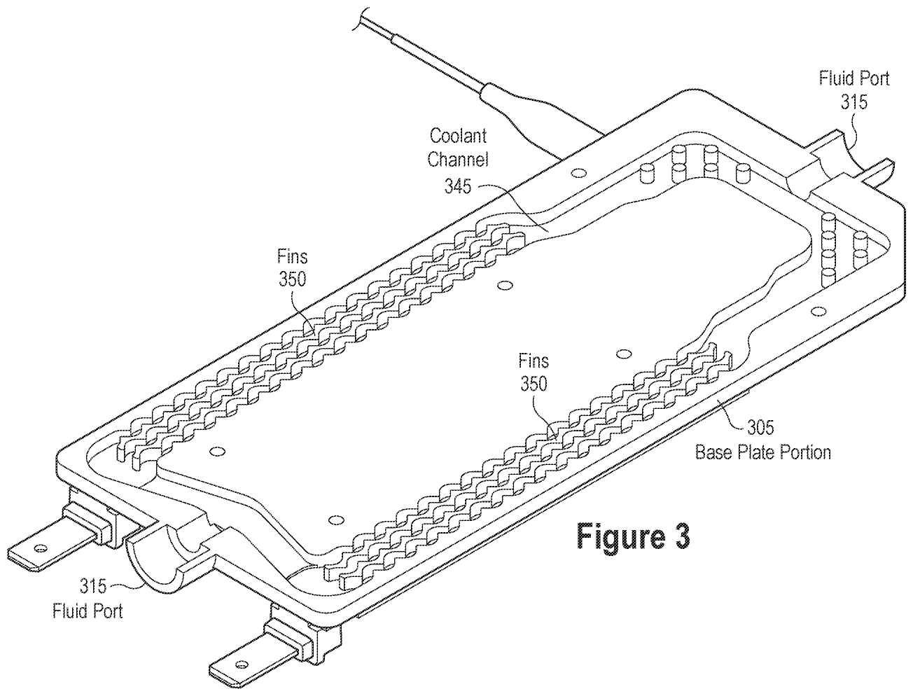

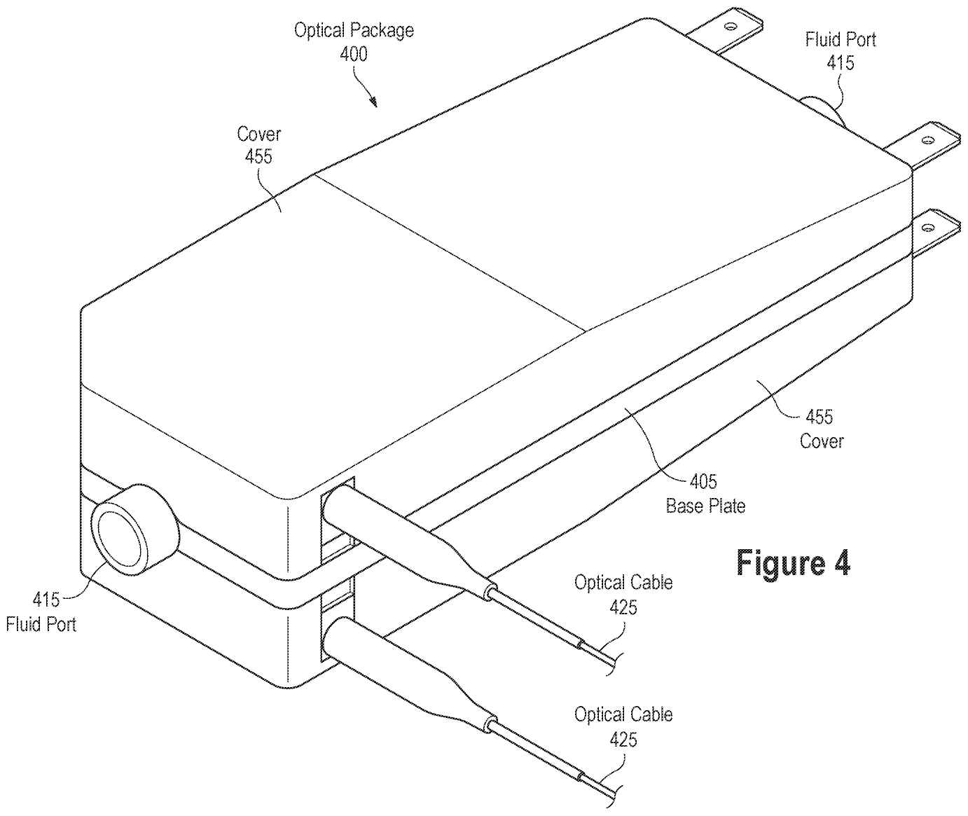

FIGS. 1 and 2 depict an example of an optical package that includes a dual-sided base plate, in accordance with embodiments herein. Specifically, FIG. 1 illustrates a simplified view of a dual-sided optical package 100, in accordance with various embodiments. FIG. 2 illustrates an alternative simplified view of the dual-sided optical package 100 of FIG. 1, in accordance with various embodiments. It will be understood that the optical package 100 depicted and described with respect to FIGS. 1 and 2 is intended as a simplified view of such an optical package. Similarly, the elements depicted and described with respect to FIGS. 3 and 4 are intended as simplified examples of embodiments herein. Unless indicated otherwise, the specific number, arrangement, size, etc. of the depicted elements is not intended to be limiting, and may be different in different embodiments. Some elements (e.g., a cover) may not be specifically depicted or described in certain of the Figures (e.g., FIGS. 1 and 2), while they may be present in other Figures (e.g., FIG. 4), however alternative embodiments or implementations of the embodiments described with respect to those Figures may include (or, in some cases, exclude) those elements.

The optical package 100 may include a base plate 105. The base plate 105 may be formed of or include, for example, a material such as copper, aluminum, graphite, a ceramic material, diamond, and/or alloys or combinations thereof. In other embodiments, the base plate 105 may additionally or alternatively include one or more other materials.

The base plate 105 may include a coolant channel through which a liquid coolant may flow. The liquid coolant may be, for example, water, a dielectric fluid, a mineral oil, a refrigerant, or some other type of liquid coolant. The coolant channel may be internal to the base plate 105 and be allowed to enter and/or exit the base plate via one or more fluid ports 115 of the base plate as shown in FIGS. 1 and 2, and described in greater detail with respect to FIG. 3.

In some embodiments, the base plate 105 may be manufactured through a three-dimensional (3D) printing process. That is, the base plate 105 may be manufactured through a layer-by-layer deposition of material to form the base plate. As a result, the base plate 105, including the internal coolant channel, may be a unitary physical element. In other embodiments, the base plate 105 may be formed of two or more separate portions that are then coupled with one another using an adhesive material, a welding process, a sintering process, and/or some other coupling process or technique. In these embodiments, respective ones of the portions may be 3D printed. In other embodiments, respective ones of the portions may additionally or alternatively be formed through a machining process (e.g., using a computer numerical control (CNC) machine, a chemical or physical etching process, a casting process, or some other process). In some embodiments, the base plate 105 or different portions of the base plate 105 may be milled (e.g., through use of a mechanism that is configured to remove material from an interior portion of the base plate 105 and/or portions of the base plate). It will be understood that these descriptions of the manufacture of the base plate 105 are intended as examples of how such manufacture may occur, and other processes or techniques may be used in other embodiments.

The base plate 105 may have a height (as indicated as the distance between H and H′ in FIG. 2) of between approximately 5 and approximately 20 millimeters (mm). As may be seen in FIG. 2, the distance between H and H′ may be viewed as the distance between a first side of the base plate 105 to which a first set of optics 110a is coupled to a second side of the base plate 105 to which a second set of optics 110b is coupled. In this embodiment, if the base plate 105 is between approximately 5 mm and approximately 20 mm, then the total height of the resultant optical package 100 (which may, for example, include a cover element as shown in FIG. 4), may be between approximately 25 mm and approximately 60 mm. In some specific embodiments, the total height of the resultant optical package 100 may be, for example, between approximately 30 mm and approximately 55 mm. More specifically, the total height of the resultant optical package 100 may be approximately 37 mm. It will be noted that these values are provided for the basis of an example of one embodiments, and in some embodiments or use cases, the height of the base plate 105 may be larger (e.g., on the order of approximately 30 mm or 40 mm).

The first set of optics 110a and the second set of optics 110b may each include a variety of optical elements coupled to the first and second sides of the base plate 105. For example, the first and second sets of optics 110a/110b may include one or more laser diodes 130. The laser diodes 130 may additionally or alternatively be referred to as “emitters.” Generally, the laser diodes 130 may be configured to generate, based on receipt of an electrical signal, an optical signal. The optical signal may be more commonly referred to as “light” and may have a wavelength in the visible spectrum, the infrared spectrum, the ultraviolet spectrum, and/or some other spectrum. In some embodiments, the laser diodes 130 may emit the light in pulses based on the electrical signal, and such pulses may be used to encode information into the resultant optical signal output from the optical package 100.

The first and second sets of optics 110a/110b may further include one or more optical components 135 that may alter the optical signal in some way. The optical signal may be injected from the laser diode(s) 130 into one or more optical components 135. The optical components 135 may include components such as one or more lenses, mirrors, or some other type of optical component. It will be noted that, in FIGS. 1 and 2, each and every laser diode 130 and optical component 135 is note labeled for the sake of clarity of the Figure.

The first and second sets of optics 110a/110b may further an optical cable coupling 120 that is configured to facilitate transfer of the optical signal from the optical components 135 (and the optical package 100 in general) to an optical cable 125. The optical cable 125 may be considered to be separate from, but coupled with, the optical package 100. The optical cable 125 may be, for example, a fiber optic cable or some other type of optical cable 125 that is configured to allow the optical signal to propagate through the optical cable 125.

In some embodiments, the specific configurations of the laser diode(s) 130, the optical components 135, etc. may be repeated between the first and second sets of optics 110a/110b. That is, the configurations of the first and second sets of optics 110a/110b may be same. In this embodiment, a characteristic (e.g., a wavelength) of the resultant optical signal output by the first set of optics 110a to an optical cable 125 may be the same as a characteristic of the resultant optical signal output by the second set of optics 110b to another optical cable 125.

In other embodiments, the configurations of the laser diode(s) 130, the optical components 135, etc. may be different between the first and second sets of optics 110a/110b. That is, the configurations of the first and second sets of optics 110a/110b may be different. In this embodiment, a characteristic (e.g., a wavelength) of the resultant optical signal output by the first set of optics 110a to an optical cable 125 may be different than a characteristic of the resultant optical signal output by the second set of optics 110b to another optical cable 125. Such an embodiment may be desirable if the two optical cables 125 converge into a single cable that carries a multiplexed signal based on the different optical signals output by the first and second sets of optics 110a/110b.

In some embodiments, the first or second set of optics 110a/110b may not include an optical cable coupling 120. Rather, the optical package 100 may only include a single optical cable coupling. For the sake of example, the optical cable coupling 120 may be an element of the second set of optics 110b. In this embodiment, the optical signal output from the optical components 135 of the first set of optics 110a may be used as input to the second set of optics 110b. The optical signal may then continue to propagate through the second set of optics to be output to the optical cable 125.

In some embodiments, although laser diodes 130 are depicted as shown in two “rows” along the length of the optical package 100, in some embodiments the first or second set of optics 110a/110b may only include a single row of laser diodes 130.

It will be understood that these variations are listed for the sake of examples of different configurations of the optical package 100, and other embodiments may vary in different ways (e.g., one or more of the optical cables 125 may couple with an optical cable coupling 120 in a different configuration than the other, a fluid port 115 may be in a different location, etc.).

In some embodiments, the optical package 100 may include one or more terminals 140. The terminals 140 may be configured to provide an electrical signal to various elements of the optical package (e.g., the laser diodes 130). In some embodiments, the electrical signal provided by the terminals 140 may be information-free. That is, the signal provided by the terminals 140 may be an alternating current (AC) or direct current (DC) signal. In some embodiments, the signal provided by the terminals 140 may include information that is intended to be encoded into the optical signal. That is, the information provided by the electrical signal may be encoded, via the first and/or second sets of optics 110a/110b, into the optical signal provided to the optical cables 125. It will be understood that the specific configuration, placement, shape, etc. of the terminals 140 is depicted for the sake of example only and, in other embodiments, one or more of the terminals 140 may have a different configuration, placement, and/or shape than is depicted or than another one of the terminals 140.

FIG. 3 illustrates a simplified view of a portion 305 of a base plate of a dual-sided optical package, in accordance with various embodiments. Specifically, FIG. 3 depicts an example cross-sectional view along line L-L′ of the base plate 105 as shown in FIG. 2. As previously described with respect to base plate 105, FIG. 3 depicts a coolant channel 345 in the base plate portion 305. The coolant channel 345 may allow for a liquid coolant to move between the fluid ports 315 (which may be similar to fluid ports 115), as well as into and out of the optical package.

The coolant channel 345 may include a number of fins 350, through which the liquid coolant may flow. The fins 350 may be formed of a same material or a different material than that of the base plate portion 305. It will be noted that the specific number or configuration of the fins 350 is depicted for the sake of example and discussion only, and is not intended to limit embodiments of the present disclosure to a specific configuration.

It will be understood that when the first and second sets of optics 110a/110b are physically coupled with the base plate 105, they may be thermally coupled with the liquid coolant in the coolant channel 345. In that way, the coolant channel 345 may assist with the removal of heat from the various laser diodes 130 and/or optical components 135.

FIG. 4 illustrates an alternative simplified view of a dual-sided optical package 400, in accordance with various embodiments. As may be seen, the optical package 400 may include fluid ports 415 and base plate 405, which may be respectively similar to fluid ports 115 and base plate 105. The optical package 400 may be coupled with optical cables 425 in a manner similar to the coupling of optical package 100 and optical cables 125 described above.

In embodiments, the optical package 400 may further include a cover 455. The cover 455 may be, for example aluminum, copper, steel, plastic, or some combinations or alloys of one or more of the discussed materials. It will be understood that the specific shape or size of the cover 455 depicted in FIG. 4 is intended as one example, and other embodiments may include a different cover with a different size or shape, either objectively or relative to the base plate 405.

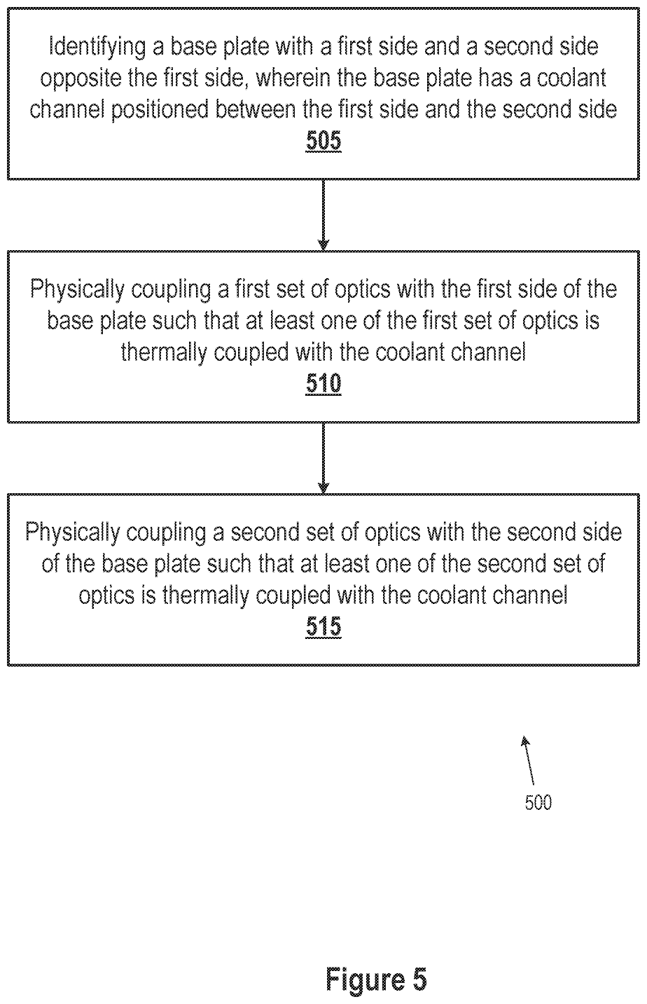

FIG. 5 illustrates an example process 500 for manufacturing an optical package such as optical package 100 (or some other optical package described herein). The process 500 may be performed, for example, by the system 600 (e.g., computing device).

The process 500 may include identifying, at 505, a base plate with a first side and a second side opposite the first side. The base plate may have a coolant channel positioned between the first side and the second side. The base plate may be similar to, for example, base plate 105 which has a coolant channel similar to coolant channel 345 positioned between the first side to which a first set of optics (e.g., element 110a) may be attached and a second side to which a second set of optics (e.g., element 110b) may be attached.

The process 500 may further include physically coupling, at 510, a first set of optics (e.g., element 110a) with the first side of the base plate (e.g., element 105). Such coupling may include a variety of elements. For example, the coupling may include coupling one or more laser diodes (e.g., element 130) or optical components (e.g., elements 135) to the first side of the base plate. The coupling may be performed through use of an adhesive, soldering, or some other form of coupling. In some embodiments, certain of the elements may be placed onto the first side of the base plate using a temporary coupling element (e.g., a weak adhesive), and then adjusted or focused before the coupling process is finalized through application of a stronger coupling element such as a stronger adhesive, an epoxy coating or filling, soldering, etc. For example, one or more lenses or mirrors may be adhered to the base plate using a weak adhesive, and then adjusted before being the application of the stronger coupling element. In another embodiment, elements (e.g., elements 130 or 135) may be attached to the base plate (e.g., element 105) via robotic tooling using an adhesive. Subsequently, a cure process (e.g., ultraviolet cure or some other cure) may be performed to more permanently adhere the elements to the base plate. A further adhesion process (e.g., application of heat to the base plate and/or elements) may be performed to more fully cure the adhesive.

As described above, in some embodiments physically coupling an element of the first set of optics (e.g., a laser diode and/or an optical component) with the base plate may thermally couple the element with the liquid coolant in the coolant channel such that the liquid coolant may remove heat from the element in particular and, more generally, the optical package.

The process 500 may further include physically coupling, at 515, a second set of optics (e.g., element 110b) with the second side of the base plate (e.g., base plate 105). Such a coupling may be performed in a manner similar to that described above with respect to element 510. In some embodiments, the coupling process of element 510 may be completed (e.g., the application of the stronger coupling element) before the coupling at 515 is initiated. In other embodiments, the coupling at 515 may at least partially overlap the coupling at 510. As noted with respect to element 510, physically coupling the second set of optics with the second side of the base plate may result in one or more of the elements of the second set of optics being thermally coupled with the liquid coolant in the coolant channel.

It should be understood that the actions described in reference to FIG. 5 may not necessarily occur in the described sequence. For example, certain elements may occur in an order different than that described, concurrently with one another, etc. In some embodiments, the process 500 may include more or fewer elements than depicted or described.

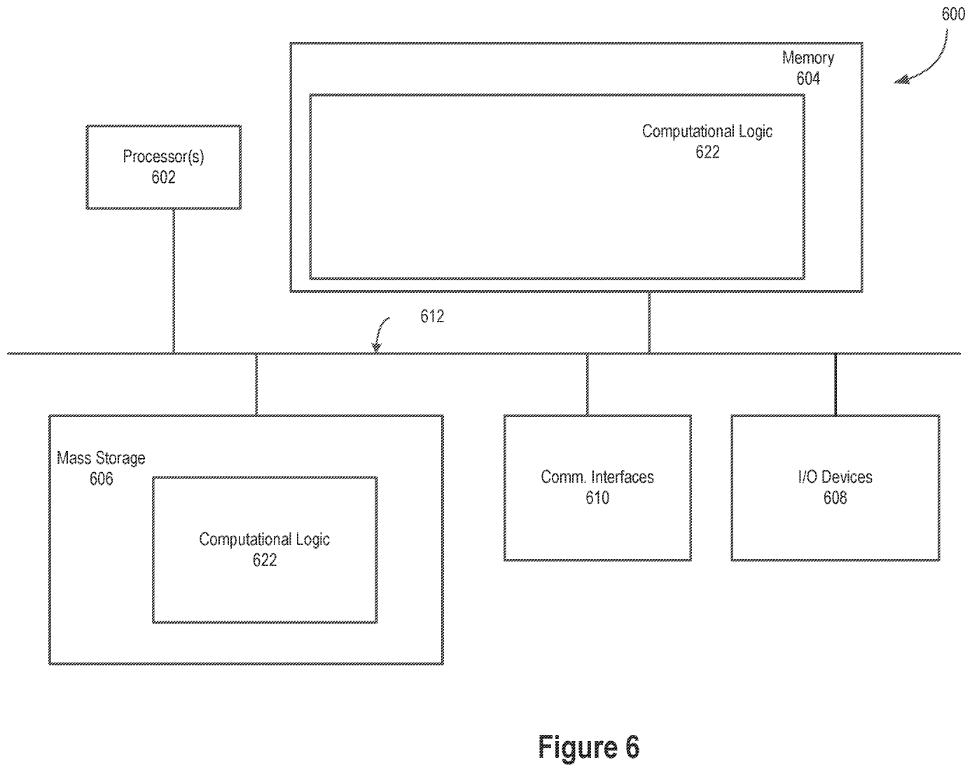

FIG. 6 illustrates an example computing device 600 suitable for use to practice aspects of the present disclosure, in accordance with various embodiments. For example, the example computing device 600 may be suitable to implement the functionalities associated with FIG. 5, and/or some other Figure, process, technique, or method described herein, in whole or in part. More specifically, the computing device 600 may be configured to control the 3D printing of a base plate such as base plate 105, and/or to perform a manufacturing process such as that described with respect to FIG. 5.

As shown, computing device 600 may include one or more processors 602, each having one or more processor cores, and system memory 604. The processor 602 may include any type of unicore or multi-core processors. Each processor core may include a central processing unit (CPU), and one or more level of caches. The processor 602 may be implemented as an integrated circuit. The computing device 600 may include mass storage devices 606 (such as diskette, hard drive, volatile memory (e.g., dynamic random access memory (DRAM)), compact disc read only memory (CD-ROM), digital versatile disk (DVD) and so forth). In general, system memory 604 and/or mass storage devices 606 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computing device 600 may further include input/output (I/O) devices 608 such as a display, keyboard, cursor control, remote control, gaming controller, image capture device, one or more three-dimensional cameras used to capture images, and so forth, and communication interfaces 610 (such as network interface cards, modems, infrared receivers, radio receivers (e.g., Bluetooth), and so forth). I/O devices 608 may be suitable for communicative connections with three-dimensional cameras or user devices. In some embodiments, I/O devices 608 when used as user devices may include a device necessary for implementing the functionalities of receiving an image captured by a camera.

The communication interfaces 610 may include communication chips (not shown) that may be configured to operate the device 600 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 610 may operate in accordance with other wireless protocols in other embodiments.

The above-described computing device 600 elements may be coupled to each other via system bus 612, which may represent one or more buses. In the case of multiple buses, they may be bridged by one or more bus bridges (not shown). Each of these elements may perform its conventional functions known in the art. In particular, system memory 604 and mass storage devices 606 may be employed to store a working copy and a permanent copy of the programming instructions implementing the operations and functionalities associated with FIG. 5, and/or some other Figure, method, technique, or process described herein, in whole or in part, generally shown as computational logic 622. Computational logic 622 may be implemented by assembler instructions supported by processor(s) 602 or high-level languages that may be compiled into such instructions.

The permanent copy of the programming instructions may be placed into mass storage devices 606 in the factory, or in the field, though, for example, a distribution medium (not shown), such as a compact disc (CD), or through communication interfaces 610 (from a distribution server (not shown)).

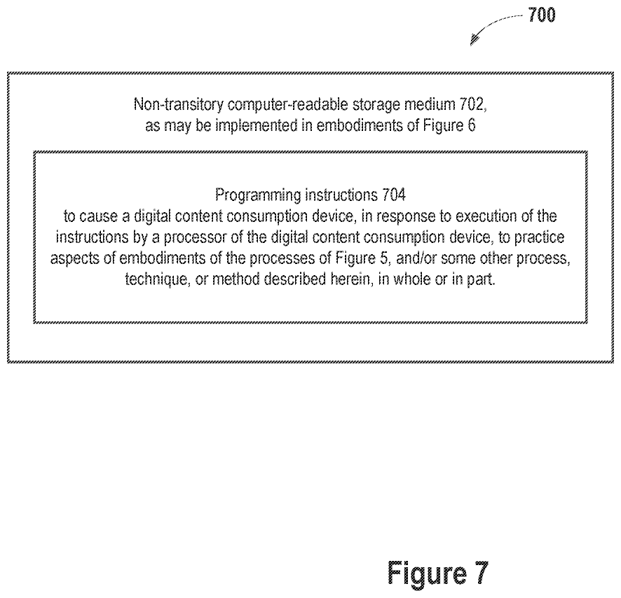

FIG. 7 illustrates an example non-transitory computer-readable storage media 702 having instructions configured to practice all or selected ones of the operations associated with the processes described above. As illustrated, non-transitory computer-readable storage medium 702 may include a number of programming instructions 704. Programming instructions 704 may be configured to enable a device, e.g., computing device 600, in response to execution of the programming instructions, to perform one or more operations of the processes described in reference to FIG. 5, and/or some other Figure, technique, process, or method described herein, in whole or in part. In alternate embodiments, programming instructions 704 may be disposed on multiple non-transitory computer-readable storage media 702 instead. In still other embodiments, programming instructions 704 may be encoded in transitory computer-readable signals.

Some non-limiting examples of various embodiments are provided below.

Example 1 includes an optical package comprising: a base plate with a first side and a second side opposite the first side, wherein the base plate has a coolant channel positioned between the first side and the second side; a first set of optics coupled with the first side of the base plate, wherein at least one of the first set of optics is thermally coupled with the coolant channel; and a second set of optics coupled with the second side of the base plate, wherein at least one of the second set of optics is thermally coupled with the coolant channel.

Example 2 includes the optical package of example 1, and/or some other example herein, wherein the base plate is a unitary physical element.

Example 3 includes the optical package of any of examples 1-2, and/or some other example herein, wherein the base plate includes: an input fluid port by which liquid coolant can flow into the coolant channel; and an output fluid port by which the liquid coolant can flow out of the coolant channel.

Example 4 includes the optical package of example 3, and/or some other example herein, wherein the liquid coolant includes water, a dielectric fluid, a mineral oil, or a refrigerant.

Example 5 includes the optical package of any of examples 1-4, and/or some other example herein, wherein the base plate includes copper, aluminum, graphite, a ceramic material, or diamond.

Example 6 includes the optical package of any of examples 1-5, and/or some other example herein, wherein the first set of optics has a same physical configuration as the second set of optics.

Example 7 includes the optical package of any of examples 1-5, and/or some other example herein, wherein the first set of optics has a different physical configuration than the second set of optics.

Example 8 includes the optical package of any of examples 1-7, and/or some other example herein, wherein: the first set of optics includes a first diode, a first optical component, and a first optical fiber coupling; and the second set of optics includes a second diode, a second optical component, and a second optical fiber coupling.

Example 9 includes the optical package of example 8, and/or some other example herein, wherein the first or second optical component is a lens or a mirror.

Example 10 includes the optical package of example 8, and/or some other example herein, wherein light emitted into an optical fiber from the first set of optics has a different wavelength than light emitted into an optical fiber from the second set of optics.

Example 11 includes the optical package of example 8, and/or some other example herein, wherein light emitted into an optical fiber from the first set of optics has a same wavelength as light emitted into an optical fiber from the second set of optics.

Example 12 includes the optical package of any of examples 1-12, and/or some other example herein, wherein the base plate has a height as measured from the first side to the second side of between 5 and 20 millimeters (mm).

Example 13 includes a base plate for use in an optical package, wherein the base plate comprises: a first side to physically couple with a first set of optics that includes a first laser diode; a second side to physically couple with a second set of optics that includes a second laser diode; a coolant channel positioned between the first side and the second side; an input fluid port configured to allow liquid coolant to flow into the coolant channel; and an output fluid port configured to allow the liquid coolant to flow from the coolant channel; wherein the liquid coolant is to thermally couple with the first laser diode when the first laser diode is physically coupled with the first side, and the liquid coolant is to thermally couple with the second laser diode when the second laser diode is physically coupled with the second side.

Example 14 includes the base plate of example 13, and/or some other example herein, wherein the base plate is a unitary physical element.

Example 15 includes the base plate of any of examples 13-14, and/or some other example herein, wherein the liquid coolant includes water, a dielectric fluid, a mineral oil, or a refrigerant.

Example 16 includes the base plate of any of examples 13-15, and/or some other example herein, wherein the base plate includes copper, aluminum, graphite, a ceramic material, or diamond.

Example 17 includes the base plate of any of examples 13-16, and/or some other example herein, wherein the first set of optics has a same physical configuration as the second set of optics.

Example 18 includes the base plate of any of examples 13-16, and/or some other example herein, wherein the first set of optics has a different physical configuration than the second set of optics.

Example 19 includes the base plate of any of examples 13-18, and/or some other example herein, wherein: the first set of optics further includes a first lens and a first optical fiber coupling; and the second set of optics includes a second lens and a second optical fiber coupling.

Example 20 includes the base plate of any of examples 13-19, and/or some other example herein, wherein the base plate has a height as measured from the first side to the second side of between 5 and 20 millimeters (mm).

Example 21 includes a method of forming an optical package, wherein the method comprises: identifying a base plate with a first side and a second side opposite the first side, wherein the base plate has a coolant channel positioned between the first side and the second side; physically coupling a first set of optics with the first side of the base plate such that at least one of the first set of optics is thermally coupled with the coolant channel; and physically coupling a second set of optics with the second side of the base plate such that at least one of the second set of optics is thermally coupled with the coolant channel.

Example 22 includes the method of example 21, and/or some other example herein, further comprising adjusting, subsequent to the physical coupling of the first set of optics and prior to the physical coupling of the second set of optics, a physical pose of a lens or mirror of the first set of optics.

Example 23 includes the method of example 22, and/or some other example herein, further comprising securing, subsequent to the adjusting and prior to the physical coupling of the second set of optics, the physical pose of the lens or mirror of the first set of optics.

Example 24 includes the method of any of examples 21-23, and/or some other example herein, wherein the base plate is a unitary physical element.

Example 25 includes the method of any of examples 21-24, and/or some other example herein, wherein, subsequent to the physical coupling of the first and second sets of optics, the first set of optics has a same physical configuration as the second set of optics.

Example 26 includes the method of any of examples 21-24, and/or some other example herein, wherein, subsequent to the physical coupling of the first and second sets of optics, the first set of optics has a different physical configuration than the second set of optics.

Example 27 includes the method of any of examples 21-26, and/or some other example herein, wherein: the first set of optics includes a first diode, a first optical component, and a first optical fiber coupling; and the second set of optics includes a second diode, a second optical component, and a second optical fiber coupling.

In the preceding detailed description, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, although certain embodiments have been illustrated and described herein for purposes of description, this application is intended to cover any adaptations or variations of the embodiments discussed herein. Therefore, it is manifestly intended that embodiments described herein be limited only by the claims.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner. Where the disclosure recites “a” or “a first” element or the equivalent thereof, such disclosure includes one or more such elements, neither requiring nor excluding two or more such elements.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

What is claimed is:

1. An optical package comprising:
a base plate with a first side and a second side opposite the first side, wherein the base plate has a coolant channel positioned between the first side and the second side;
a first set of optics coupled with the first side of the base plate, wherein at least one of the first set of optics is thermally coupled with the coolant channel; and
a second set of optics coupled with the second side of the base plate, wherein at least one of the second set of optics is thermally coupled with the coolant channel.

2. The optical package of claim 1, wherein the base plate is a unitary physical element.

3. The optical package of claim 1, wherein the base plate includes:
an input fluid port by which liquid coolant can flow into the coolant channel; and
an output fluid port by which the liquid coolant can flow out of the coolant channel.

4. The optical package of claim 1, wherein the base plate includes copper, aluminum, graphite, a ceramic material, or diamond.

5. The optical package of claim 1, wherein the first set of optics has a same physical configuration as the second set of optics.

6. The optical package of claim 1, wherein the first set of optics has a different physical configuration than the second set of optics.

7. The optical package of claim 1, wherein:
the first set of optics includes a first diode, a first optical component, and a first optical fiber coupling; and
the second set of optics includes a second diode, a second optical component, and a second optical fiber coupling.

8. The optical package of claim 1, wherein the base plate has a height as measured from the first side to the second side of between 5 and 20 millimeters (mm).

9. A base plate for use in an optical package, wherein the base plate comprises:
a first side to physically couple with a first set of optics that includes a first laser diode;
a second side to physically couple with a second set of optics that includes a second laser diode;
a coolant channel positioned between the first side and the second side;
an input fluid port configured to allow liquid coolant to flow into the coolant channel; and
an output fluid port configured to allow the liquid coolant to flow from the coolant channel;
wherein the liquid coolant is to thermally couple with the first laser diode when the first laser diode is physically coupled with the first side, and the liquid coolant is to thermally couple with the second laser diode when the second laser diode is physically coupled with the second side.

10. The base plate of claim 9, wherein the base plate is a unitary physical element.

11. The base plate of claim 9, wherein the liquid coolant includes water, a dielectric fluid, a mineral oil, or a refrigerant.

12. The base plate of claim 9, wherein the base plate includes copper, aluminum, graphite, a ceramic material, or diamond.

13. The base plate of claim 9, wherein:
the first set of optics further includes a first lens and a first optical fiber coupling; and
the second set of optics includes a second lens and a second optical fiber coupling.

14. The base plate of claim 9, wherein the base plate has a height as measured from the first side to the second side of between 5 and 20 millimeters (mm).

15. A method of forming an optical package, wherein the method comprises:
identifying a base plate with a first side and a second side opposite the first side, wherein the base plate has a coolant channel positioned between the first side and the second side;
physically coupling a first set of optics with the first side of the base plate such that at least one of the first set of optics is thermally coupled with the coolant channel; and
physically coupling a second set of optics with the second side of the base plate such that at least one of the second set of optics is thermally coupled with the coolant channel.

16. The method of claim 15, further comprising adjusting, subsequent to the physical coupling of the first set of optics and prior to the physical coupling of the second set of optics, a physical pose of a lens or mirror of the first set of optics.

17. The method of claim 15, wherein the base plate is a unitary physical element.

18. The method of claim 15, wherein, subsequent to the physical coupling of the first and second sets of optics, the first set of optics has a same physical configuration as the second set of optics.

19. The method of claim 15, wherein, subsequent to the physical coupling of the first and second sets of optics, the first set of optics has a different physical configuration than the second set of optics.

20. The method of claim 15, wherein:
the first set of optics includes a first diode, a first optical component, and a first optical fiber coupling; and
the second set of optics includes a second diode, a second optical component, and a second optical fiber coupling.
